(19) United States
(12) Patent Application Publication
(10) Pub. No.: US 2018/0121531 A1
(43) Pub. Date: May 3, 2018

(54) Data Updating Method, Device, and Related System

(71) Applicant: Alibaba Group Holding Limited, Grand Cayman (KY)

(72) Inventors: Yuanyuan Dong, Hangzhou (CN); Weibin Yan, Hangzhou (CN); Chao Shi, Hangzhou (CN); Li Xu, Hangzhou (CN); Leilei Tian, Hangzhou (CN)

(21) Appl. No.: 15/852,653

(22) Filed: Dec. 22, 2017

Related U.S. Application Data
(63) Continuation of application No. PCT/CN2016/086106, filed on Jun. 17, 2016.

(30) Foreign Application Priority Data
Jun. 26, 2015 (CN) 201510363437.6

(51) Int. Cl. G06F 17/30; G06F 3/06; H04L 29/08

(52) U.S. Cl. CPC G06F 17/30575; G06F 17/30345; H04L 67/1097; G06F 3/067; G06F 17/30309

(57) ABSTRACT

A method including sending an update request to replica servers listed in a copy list respectively; receiving respective response information from a respective replica server of the replica servers after an update of a respective data copy in the respective replica server is completed; in response to determining that a number of response information received in a preset update time is less than a total number of the replica servers, modifying a status of copy information corresponding to a replica server that has not sent a response information to a status of continuing to update; in response to determining that response information from the replica servers with the status of continuing to update has not been received within a preset continuous update time, deleting corresponding copy information; updating a list attribute value of the copy list; and sending the updated list attribute value to a central server.

### CROSS REFERENCE TO RELATED PATENT APPLICATIONS

This application claims priority to and is a continuation of PCT Patent Application No. PCT/CN2016/086106, filed on 17 Jun. 2016, which claims priority to Chinese Patent Application No. 201510363437.6, filed on 26 Jun. 2015, entitled “Data Updating Method, Device, and Related System,” which are hereby incorporated by reference in their entirety.

### TECHNICAL FIELD

The present disclosure relates to the field of distributed storage technologies, and, more particularly, to data updating methods, apparatuses, and related systems.

### BACKGROUND

As networks penetrate all industries in the society, the amount of data that needs to be stored in the back end of the network becomes larger and larger, and usually a large amount of data needs to be stored every day. Traditional network storage stores data in a centralized server, which causes not only a storage load balance problem, but also security risks. In order to meet the demand of large-scale data storage, the storage method commonly used today is distributed storage. Distributed storage refers to the data being stored as multiple copies, and each copy is stored in a corresponding replica server. The storage load is shared by multiple replica servers, and the storage reliability is also improved.

Because the data copies are stored in multiple replica servers, the client terminal maintains a copy list in which each data copy of the data and the replica server address corresponding to each data copy are recorded. When the data is updated, the client terminal sends an update request to all replica server addresses stored in the copy list, and all data copies are updated at the same time. After the data copy in a replica server is completely updated, the replica server sends the client terminal a response information containing the data copy version number. When reading/writing data, if there is any failure of one or more replica servers, network failure or disk failure which causes unstable I/O performance, the data copies in some replica server cannot be successfully updated. To solve such a problem, the conventional data updating method is as follows. After the client terminal sends the data update request to each replica server, the client terminal starts to count. If the number X of the response information received by the client terminal within a preset update time period is greater than or equal to a preset threshold M, the data update is deemed successful, and the X updated data copies are used as effective copies. The preset threshold M is smaller than the total number of replica servers N. M, N, and X are natural numbers. Thus, the system is able to tolerate performance jitter of (N-M) replica servers.

As the client terminal stores the copy list of data through the memory, if the client terminal crashes, all the stored data will be lost, resulting in the client terminal being unable to determine the current version number of the data and unable to continue to update the data. When the data is updated again, the client terminal only needs to send the update request to the replica server whose data copy has the current version number. Therefore, the replica server whose data copy is not updated successfully is excluded based on the current version number. When the client terminal dies, the current version of the data needs to be restored. The conventional processing method is that when X is less than N, the current version number corresponding to the valid X data copies is stored in a central server. After the client terminal crashes, the current version number is read from the central server so that the current version number is used to determine a valid data copy and its corresponding replica server, which excludes the server corresponding to the data copy that is unsuccessfully updated.

As I/O performance jitter has a large impact on the system, in order to ensure system stability, the common practice is to set a short update time period to weaken I/O performance jitter. Thus, on one hand, the probability of I/O performance jitter is reduced; on the other hand, the date update is completed before I/O performance jitter occurs. However, the shorter the update time period, the higher the probability of generating data copy that does not complete data update is at each data update. Thus, the data needs to be written to the central server more frequently, resulting in storage pressure and performance bottlenecks of the central server and a reduction of system availability.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure. The present disclosure provides a method and device for multi-display interaction, which makes the interaction process more vivid and real, which improves the user engagement.

In view of the problems of the conventional techniques, the example embodiments of the present disclosure provide a data updating method, device and related system, which reduce the frequency of writing data to the central server based on the reduction of the I/O performance jitter, thereby reducing the pressure on the central server and improving system usability.

According to a first aspect, an example embodiment of the present disclosure provides a data updating method, which includes:

after sending update requests to replica servers listed in a copy list, receiving response information from a respective replica server after a data update in the respective replica server is completed; when the number of the response information received in a preset update time is less than the total number of the replica servers, modifying the copy information corresponding to replica servers that have not sent the response information to status of continuing to update;

when response information from the replica servers with the status of continuing to update have not been received within a preset continuous update time, deleting copy information corresponding to the replica servers with the status of continuing to update from the copy list; and

updating list attribute values of the copy list and sending and storing the updated list attribute values to the central server.

According to a second aspect, an example embodiment of the present disclosure further provides a data updating device, which includes:

a receiving module that, after sending update requests to replica servers listed in a copy list, receives response information from a respective replica server after a data update in the respective replica server is completed;

a status modifying module that, when the number of the response information received in a preset update time is less than the total number of the replica servers, modifies the copy information corresponding to replica servers that have not sent the response information to status of continuing to update;

a deleting module that, when response information from the replica servers with the status of continuing to update have not been received within a preset continuous update time, deletes information of the replicas corresponding to the replica servers with the status of continuing to update from the copy list;

an updating module that updates list attribute values of the copy list after the deleting module deletes the copy information corresponding to the replica servers with the status of continuing to update from the copy list; and

a sending module that sends and stores the updated list attribute values to the central server.

According to a third aspect, an example embodiment of the present disclosure further provides a data updating system which includes a client terminal, one or more replica servers, and a central server. The client terminal may be the data updating device as described in the second aspect. The replica server receives the list attribute values sent by the client terminal. The central server receives the list attribute values sent by the client terminal.

As shown from the above technical solutions, in order to solve the problem of low system usability, in the data updating method and apparatus and the related system provided by the example embodiments of the present disclosure, after the client terminal respectively sends update requests to the replica servers listed in the copy list, the client terminal receives response information from each replica server after a data update in each replica server is completed. When the number of the response information received in a preset update time is less than the total number of the replica servers, there exists the replica servers that have not been updated successfully. The techniques of the present disclosure do not exclude such replica servers then. Instead, the status of information of copies stored at the corresponding replica servers that have not sent the response information are changed to status of continuing to update to keep such replica server for continuous updating. When response information from the replica servers with the status of continuing to update have not been received within a preset continuous update time, the copy information corresponding to the replica servers with the status of continuing to update is deleted from the copy list so that the corresponding data copies that have not been updated are excluded from the data copies that have been completed. As the deletion of the copy information changes the list attributes of the copy list, the techniques of the present disclosure update the list attribute values of the copy list, and send and store the updated list attribute values to the central server. Compared with the conventional techniques, when there is a replica server that has not been successfully updated within the update time, the replica server does not need to be excluded. Therefore, the current version number does not need to be stored in the central server. When excluding the replica server, changes to the copy list are bound to occur. Therefore, in the example embodiment of the present disclosure, the list attribute value is stored in the central server only when the copy list changes, thereby reducing the frequency of writing data to the central server based on the reduction of the I/O performance jitter, and further reducing the pressure on the central server and improving the system availability.

### BRIEF DESCRIPTION OF THE DRAWINGS

To describe the technical solutions in the example embodiments of the present disclosure or in the conventional techniques more clearly, the following briefly introduces the accompanying FIGs used for describing the example embodiments. Apparently, the accompanying FIGs in the following description merely represent some example embodiments of the present disclosure. For those skilled in the art, other drawings may be obtained based on these FIGs without creative efforts. The above and other purposes, features and advantages of the present disclosure will be more apparent from the accompanying FIGs. The same reference numerals used throughout the FIGs refer to the same parts. The FIGs are not proportionately scaled to represent the actual size and are intended to illustrate the gist of the present disclosure.

FIG. 1 is a flowchart of a method for updating data according to an example embodiment of the present disclosure;

FIG. 2 is a schematic diagram of information exchange for data recovery according to an example embodiment of the present disclosure;

FIG. 3 is a flow chart of a method for updating data according to another embodiment of the present disclosure;

FIG. 4 is a schematic structural diagram of a data updating device according to an example embodiment of the present disclosure; and

FIG. 5 is a schematic structural diagram of a data updating system according to an example embodiment of the present disclosure.

### DETAILED DESCRIPTION

As the client terminal maintains a copy list of the data, the copy list records the copy information corresponding to each copy. When the client terminal needs to exclude the replica server that has not been successfully updated, the client terminal may delete the copy information corresponding to the replica server. Therefore, in order to solve the existing technical problem in the conventional techniques, the technical solution in the example embodiment of the present disclosure is implemented by using the characteristic.

The technical solutions in the example embodiments of the present disclosure are clearly and completely described below with reference to the accompanying FIGs in the example embodiments of the present disclosure. Apparently, the described embodiments are merely a part but not all embodiments of the present disclosure. All other embodiments obtained by a person of ordinary skill in the art based on the example embodiments of the present disclosure without creative efforts shall fall within the protection scope of the present disclosure.

In the conventional techniques, the update time has a direct impact on the I/O performance of the system and the frequency of storing data to the central server. However, if the update time is longer, although the frequency of storing data to the central server is reduced, the I/O performance jitter will have larger impact on data updates. If the update time is shorter, while minimizing the impact of I/O performance, frequent storage operations may be a result, which causes frequent storage operations, resulting in pressure on the central server and performance bottlenecks at the central server. That is, I/O performance and storage pressure at the central server cannot be balanced, thereby reducing system usability.

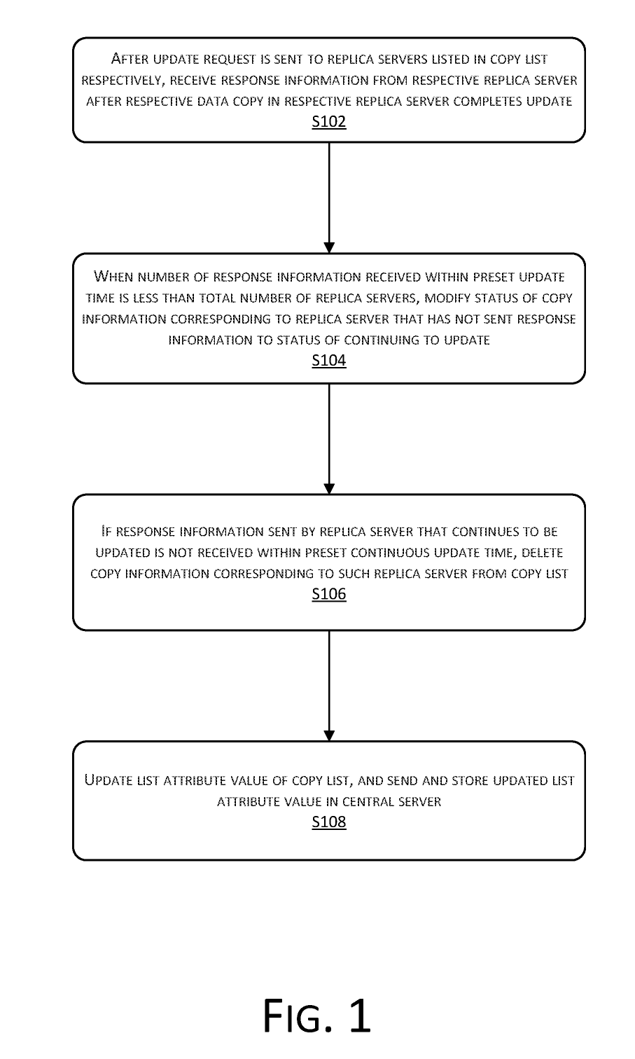

FIG. 1 is a flowchart of a data updating method according to an example embodiment of the present disclosure. The method includes the following operations:

Operation S102: after an update request is sent to replica servers listed in a copy list respectively, response information from a respective replica server is received after a respective data copy in the respective replica server completes an update.

Because distributed storage stores data as multiple data copies, each copy is correspondingly stored in one replica server. For ease of management, the client terminal manages the copy of the data and the replica server by maintaining the copy list. The format of the copy list may be as shown in Table 1, and each piece of copy information includes a list identifier, a replica server address, a copy version number, and a copy status. Certainly, Table 1 is merely an example provided for describing the format of the copy list. In some actual storing cases, the number of copies corresponding to each data may not be 3.

TABLE 1

| | Replace server | Copy version | |
|---|---|---|---|
| List Identifier | address | number | Copy status |
| 1 | Address 1 | 5.0 | Normal |
| 2 | Address 2 | 5.0 | Normal |
| 3 | Address 3 | 5.0 | Continue to update |

It should he noted that the copy status in the copy list is the status of the copy in the replica server corresponding to the corresponding replica server address. Therefore, the copy status may be adjusted according to the instruction information sent by the client terminal. For example, after the client terminal sends the update request to the replica server corresponding to the address 1, the copy stored in the replica server needs to be updated according to the update request, and the client terminal may modify the copy status corresponding to the address 1 into updating. When the update is complete, the copy status is updated to valid. Certainly, when the copy status in the replica server is other state, the client terminal also makes corresponding changes, which is not detailed in the present disclosure.

With respect to data update, the client terminal generates an update request and sends the update request to the replica server corresponding to the replica server address. After receiving the update request, the replica server reads the version number in the update request and compares it with the stored version number of the stored data copy at the replica server. When the version number of the stored data copy is smaller than the read version number, the stored data copy is updated according to the update request. That is, the updated data is written to the disk of the replica server. After the update is completed, the replica server sends a response information of successful update to inform the client terminal that the data copy update succeeds. Therefore, in this example embodiment of the present disclosure, the response information may be a signal that does not include any data, which is not limited in the present disclosure.

Since the copy in the replica server has been updated, the corresponding version number should also be updated. Therefore, after receiving the response information sent by the replica server, the client terminal reads the replica server address corresponding to the response information and searches for the corresponding copy version number from the copy list according to the replica server address, modifies the corresponding copy version number to the current version number, and modifies the corresponding copy status to valid.

In addition, the distributed storage may set up multiple client terminals, each corresponding to multiple replica servers. However, the data stored by different client terminals is different, and the data update method and procedure in each client terminal are identical, which will not be described in detail in the present disclosure. However, different client terminals in the distributed storage may use the same replica server, so that when one of the replica servers is a replica server of another one or more client terminals at the same time. In order to send a response information to the client terminal that sent the update request, upon receiving the update request, a communication link with the corresponding client terminal is established. After the copy is updated, the established communication link may be reused, so that the response information is sent to the corresponding client terminal through the communication link.

Operation S104: When the number of the response information received within the preset update time is less than the total number of the replica servers, a status of the copy information corresponding to the replica server that has not sent the response information is modified to the status of continuing to update.

According to the conventional techniques, in order to reduce the I/O performance jitter, if the number of response information received within the update time is equal to a preset threshold, the update is deemed successful, and the update time is set in advance. Generally, the update time is set as the time that the preset threshold of copies is updated, which may be set according to historical experience values. Therefore, generally, the number of copies that is updated within the preset update time is at least the preset threshold. That is, in this example embodiment, the number of response information received within the preset update time is less than the total number of replica servers includes the cases that: the number of response information is greater than or equal to the preset threshold. Certainly, in some special cases, such as a system network delay, the number of response information received within the update time may be less than the preset threshold. At this time, the client terminal enters a waiting state until the number of received response information equals the preset threshold.

In this example embodiment of the present disclosure, when the quantity of received response information in the update time is greater than or equal to the preset threshold, and is less than the total number of replica servers, the copy status corresponding to the unresponsive replica server is changed to status of continuing to update, and time of continuing to update is recorded. Since during the time of continuing to update for the copy that has not been successfully updated, the copy that has been successfully updated at this time may need to be updated for next time. Therefore, the client terminal may send an asynchronous write command to the replica server that has not sent the response information, and switch to asynchronous writing at background for such replica server, which, together with the process for the replica server has been updated, forms two processes, thereby avoiding the interferences between the two processes.

In this example embodiment, when there is a copy that has not been completely updated within the preset update time, the replica server corresponding to such copy is not excluded instead, the copy status of such copy is changed to provide the copy with a chance to continue updating, thereby reducing the probability of writing data to the central server.

Operation S106: If the response information sent by the replica server that continues to be updated is not received within the preset continuous update time, the copy information corresponding to such replica server is deleted from the copy list.

According to the above description, during the continuous update time, another copy that has been successfully updated this time may be updated another or more times, the copy that continues to be updated for this time falls behind one or more versions of the current version in order to maintain the version consistency and reduce the operation flow, the client terminal will still send the update request to the replica server with the copy status of continuing to update so that the update is deemed successful when the copy at the replica server with the copy status of continue to update is updated to the current highest or latest version. Such replica server will send the response information to the client terminal then. For example, the version number after update this time is 5.0, and the replica server corresponding to address 3 does not send the response information within the preset update time, and its corresponding copy status is changed to continue to update. Other copies with version number 5.0 continue to be updated and the latest version number is 5.5. The address 3 sends the response information to the client terminal when the copy stored at address 3 continues to be updated to the version number 5.5.

If the replica server storing copy with the status of continuing to update still does not send the response information within the preset continuous update time, the copy with the status of continuing to update is deemed to have unsuccessful update. To ensure the consistency of the version numbers of the copies, the copy information corresponding to such replica server is deleted to exclude such replica server. For example, if the copy corresponding to address 3 fails to be updated to the version number 5.5 within the continuous update time, the client terminal will delete the copy information corresponding to address 3 to discard the copy.

It should be noted that, in order for the client terminal to perform effective copy recovery, the central server also stores an address list of the replica servers, which corresponds to the copy list at the client terminal. When the client terminal needs data recovery, the client terminal obtains the addresses of the replica servers from the address list to obtain the version number of the copy at the corresponding copy server. As the copy list at the client terminal changes frequently and the central server stores the address list corresponding to all client terminals at the distributed storage system, to ensure the address of replica servers at the central server and the client terminals are the same, the central server needs to update the address list when the copy list at any client terminal changes. Thus, the central server will always be in the status of data update, which results in massive storage pressure. To timely update the address list at the central server and reduce the storage pressure of the central server, the central server periodically sends an instruction to obtain copy information to all replica server. The replica server sends all locally stored copy information to the central server according to such instruction. The central server may, according to the received information, modifies the stored address list.

Operation S108, the list attribute value of the copy list is updated, and the updated list attribute value is sent and stored in the central server.

In the example embodiment of the present disclosure, the list attribute value is set for the copy list. The list attribute value is used to identify the attribute of the copy list, and the list attribute value is updated every time the copy list is changed. Since the copy list may change many times during the data update process, in order to express the change of the copy list, the value of the list attribute may be set in the form of the time stamp or be annotated by the monotonically increasing numeric identifier and the like, which is not limited by the present disclosure. Each time the copy list is changed, the value of the list attribute is monotonically increased by a certain amount on the previous basis, so that the change information of the copy list is clearly expressed, in this example embodiment, when the client terminal deletes a part of the copy information in the copy list, the sequence of copies in the copy list is changed, and therefore, the list attribute value of the copy list is updated. Since the copy list changes, the version numbers of copies in the original copy list are inconsistent. To facilitate data recovery after the client terminal crashes, in the example embodiment of the present disclosure, the updated list attribute value and the replica server address stored in the updated copy list are sent to the central server.

For example, after the copy information stored in address 3 of the copy list is deleted, the copy information stored in the copy list is reduced and the copy list is changed. Assuming that the list attribute value before the change of the copy list is a10, after the copy information corresponding to address 3 is deleted, the list attribute value is updated to a11. The address 1, address 2, and a11 are sent and stored to the central server.

In addition, after the copy information corresponding to the copy that does not complete update is deleted from the copy list, the copy continues to be updated. After the copy is successfully updated, the version number is the same as the version number of the valid version, the corresponding copy information is no longer stored in the copy list. When the client terminal performs data recovery, only the version number is used to identify the copy, which may cause a recognition error and reinsert the deleted copy information into the copy list. Therefore, in order to ascertain the copy information stored in the copy list, when the client terminal updates the list attribute value, at first, the updated list attribute value is sent to the replica servers that store the current copy list, respectively, so that the updated list attribute value is used to determine whether the copy stored in a respective replica server shall be stored in the copy list. Then the updated list attribute value is sent and stored to the central server.

The technical solution in the example embodiment provides a plurality of identification criteria for data recovery, so that the copy information corresponding to the valid copy is quickly and accurately identified and restored to the client terminal after the client terminal crashes.

As shown from this example embodiment, according to the data update method of the present disclosure, when a replica server that has not been successfully updated within the update time, it is not necessary to exclude such replica server and thus there is no need to store the current version number in the central server. When excluding the replica server, changes to the copy list are bound to occur. Therefore, in the example embodiment of the present disclosure, the list attribute value is stored in the central server only when the copy list changes, thereby reducing the frequency to write data into the central server based on the basis of reducing the I/O performance jitter, and further reducing the pressure on the central server and improving the system usability.

The above example embodiment describes in detail the processing method for updating data. As shown from the above description, in order to recover the valid copy after the client terminal crashes, the list attribute value is stored in the central server, and the central server updates the stored replica server address list according to a preset period. In order to make those skilled in the art understand the technical solutions of the present disclosure more clearly, based on the foregoing example embodiments, the data recovery process of the client terminal will be described in detail below.

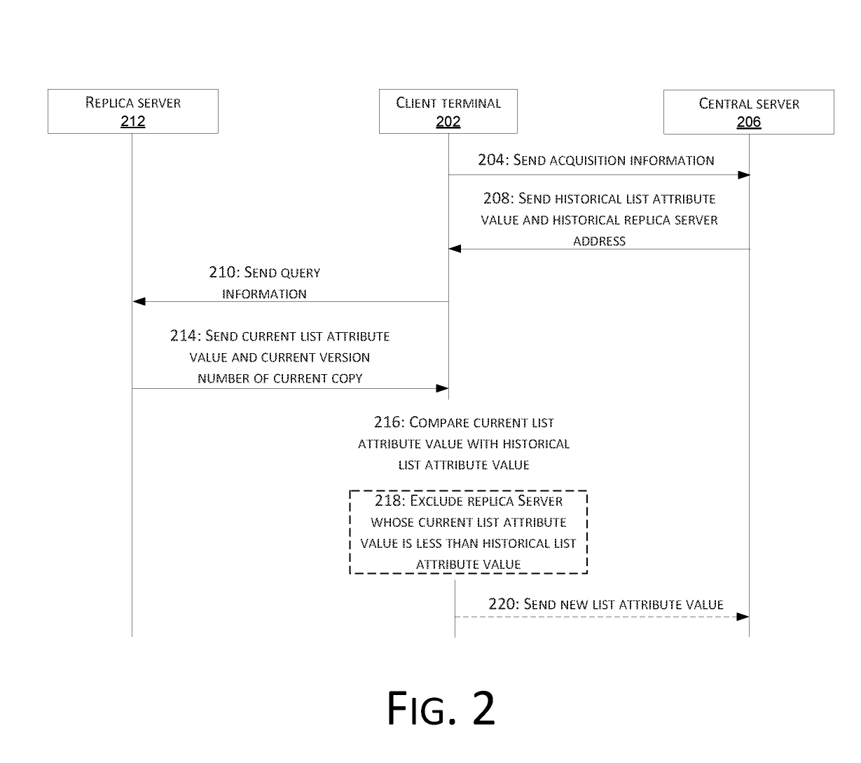

Referring to FIG. 2, FIG. 2 is a schematic diagram of information interaction of data recovery according to an example embodiment of the present disclosure. After a client terminal 202 crashes and restarts, at 204, the client terminal 202 sends the acquisition information to a central server 206. The acquisition information includes identification information of the client terminal 202. After receiving the acquisition information, the central server 206 looks up the historical list attribute value and the historical replica server address corresponding to the client terminal 202 according to the client terminal identification information and executes operation 208 to send the historical list attribute value and the historical replica server address to the client terminal 202. The historical list attribute value is the last list attribute value sent to the central server 206 by the client terminal 202, and the historical replica server address is the last address list sent by the client terminal 202 to the central server 206.

Operation 210, the client terminal 202 sends inquiry information to a replica server 212 corresponding to the historical replica server address. In operation 214, the replica server 212 responds to the inquiry information and sends a current list attribute value and a current version number of the current copy to the client terminal 202. Operation 216, the client terminal 202 compares the current list attribute value with the historical attribute value.

As shown from the above description, the address list in the central server is updated according to a preset period, and the duration of the preset period may he greater than the data update interval. When the time of updating the list attribute value is within the period of updating the address list, the historical replica server address may include the replica server address corresponding to the deleted copy. The current list attribute value corresponding to the deleted copy is less than the historical list attribute value. Thus, at 218, the client terminal 202 excludes the replica server 212 whose current list attribute value is less than the historical list attribute value.

For example, if the history list attribute value is a10, the copy information corresponding to the address 3 is deleted at the client terminal, which is an update. The address list in the central server still has 1 minute to reach the next update period. The historical replica server address includes the replica server address corresponding to address 3 and the current list attribute value of the replica server corresponding to the address 3 is a09. Thus, the copy information stored at address 3 is excluded.

In addition, after updating the list attribute value, the client terminal sends the list attribute value to the replica server corresponding to the copy list first, and then sends the list attribute value to the central server. If the client terminal crashes after the updated list attribute value is sent to the replica server, the updated list attribute value cannot be sent to the central server. Then the historical list attribute value may be less the current list attribute value corresponding to a portion of the replica servers. Then the replica servers whose current list attribute values are higher than the historical list attribute values are includes into the copy list.

For example, when the list attribute value is updated to a11, the client terminal crashes after a11 is sent to the replica server. The replica server whose current list attribute value is greater than the history list attribute value a10 belongs to the copy list and the replica server whose current list attribute value is less than or equal to a10 is the replica corresponding to the excluded copy.

In addition, at 220, the client terminal 202 sends the new list attribute value to the central server 206, the data update is performed again or more times. During the last data update, the client terminal crashes when one or more replica server are continuing update. The list attribute value is not updated. However, there generates new copies to be excluded. At that time, the replica server whose current list attribute value is equal to the historical list attribute value is listed in the copy list. The current version number corresponding to each copy information in the copy list is acquired, and the copy with the current highest or latest version number is determined as a valid copy. The copy information whose current version numbers are lower than the highest or latest version number is deleted. The list attribute value is updated again to obtain the new list attribute value. Then, operation 06 is performed to send and store the new list attribute value to the central server.

For example, if the history list attribute value is air, the version number of the valid copy is 5.5 when the list attribute value is updated to air. Then the client terminal performs two more data updates. The corresponding first version number is 5.7 after the first data update. The corresponding second version number is 6.0 after the second data update. After the preset update time of the second data update, the copy stored in address 5 is in the status of continuing to update. Then the client terminal loses power. The version number of the copy stored at address 5 is 5.7. Then, the copy list recovered according to the list attribute value includes the copy information corresponding to the address 5. After comparing the copy version numbers corresponding to the copy list, the copy corresponding to version number 6.0 is determined as a valid copy. Therefore, the copy information corresponding to address 5 is deleted, the list attribute value is updated to a11 and sent to the central server.

As shown from the above technical solutions, the techniques of the present disclosure reduce the frequency of storing data to the central server while still recover the data to the client terminal accurately and quickly through the list attribute value and the current version number, thereby reducing the system's storage pressure and performance bottlenecks without affect other performance of the system.

In addition, as shown from the foregoing example embodiment, in order to ensure the normal data update, a preset threshold is set for the updated number of copies. The data update process may take several updates in a period of time. Due to different I/O performance of different replica servers, when the data is updated several times in a row there may be no copy that is updated to highest or latest version within the preset update time. That is, no valid copy is generated. If the client terminal crashes at that time, the current valid copy cannot be determined through data recovery, and subsequent updating of the data cannot be performed. Therefore, in the conventional techniques, the preset threshold is set to be greater than half the total number of copies. For example, the total number of copies is 2N+1, then the minimal default threshold is N+1. However, such setting reduces I/O performance jitter that the system may tolerate, thereby reducing the usability of the system. Therefore, based on the foregoing example embodiment, the example embodiment of the present disclosure further provides a second data updating method.

Since this example embodiment is complementary to the above example embodiment, the part of this example embodiment that is the same as the above example embodiment may refer to the description of the above example embodiment, which is not described again in this example embodiment.

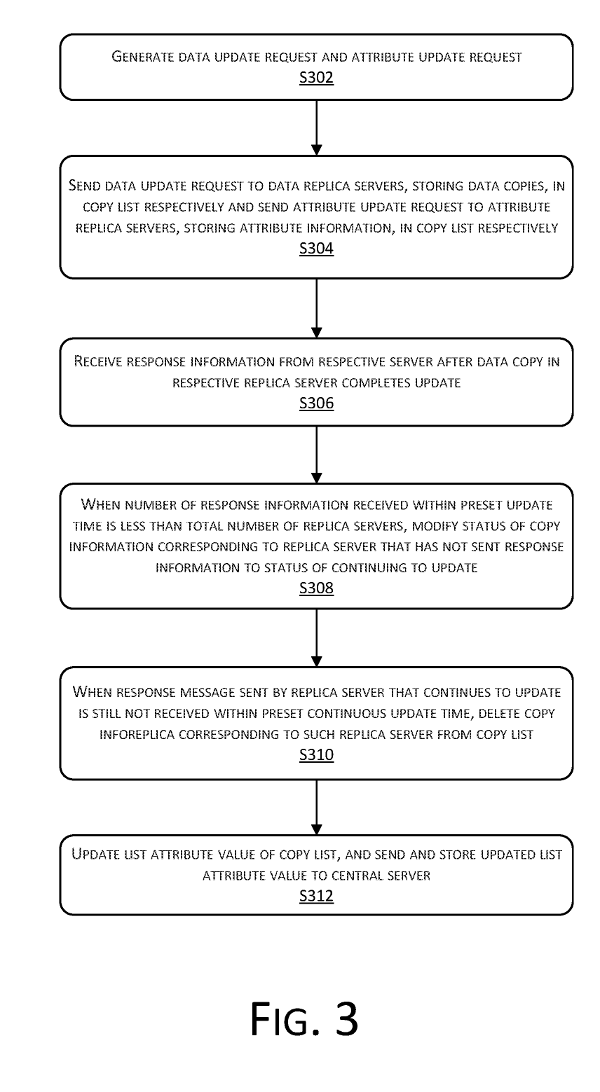

Referring to FIG. 3, FIG. 3 is a flowchart of another method for updating data according to another example embodiment of the present disclosure. The method includes the following operations:

Operation S302: a data update request and an attribute update request are generated.

In order to increase the tolerable I/O performance jitter of the system and increase system usability, in this example embodiment, an attribute copy of data is preset. The attribute copy includes only the version number corresponding to the valid copy and the list attribute value of the copy list. Each attribute copy is stored in a corresponding attribute replica server. In this example embodiment of the present disclosure, the attribute copy replaces the data copy to determine the valid copy. The copy list stores the copy information corresponding to the attribute copy. The update manner and the storage manner of the attribute copy are the same as those of the data copy, which are not detailed by the present disclosure.

It should be noted that, in this example embodiment, each data may be set to correspond at least one attribute copy, which is not limited in the present disclosure. In an example of the present disclosure, assuming that the total number of data copies is 2N+1 and the preset threshold is N+1, N attribute copies may be set.

As the copy information in the copy list corresponds to two types of copies and the attribute copy stores the version number of the data and the list attribute value of the copy list, when the data is updated, the client terminal generates two types of update requests. One is a data update request that includes updated data information and a version number. The other is an attribute update request that does not include updated data information compared to the data update request, and its other information is the same as the data update request,

In this example embodiment, by adding the attribute copy of the data, the I/O performance jitter tolerated by the system is increased. By using the attribute copy as a copy that determines the valid copy, the probability of generating valid copy is increased, and the usability of the system is improved.

Operation S304: the data update request is sent to the data replica servers, storing data copies, in the copy list respectively and the attribute update request is sent to the attribute replica servers, storing attribute information, in the copy list respectively.

As shown from the description of the foregoing example embodiment, the copy information includes a list identifier and a replica server address. In this example embodiment, the property of a copy corresponding to the copy information may be distinguished by the list identifier, and then the corresponding update request is sent to the replica server address corresponding to the list identifier.

For example, the list identifier corresponding to the data copy is “a1, a2”, and the list identifier corresponding to the attribute copy is “b1, b2”. After the client terminal generates two types of update requests, the data update requests are respectively sent to the replica server address whose list identifier includes “a” and the attribute update request is sent to the replica server address whose list identifier includes “b”.

Certainly, the foregoing is only an example of the present disclosure. In this example embodiment of the present disclosure, copy information corresponding to the data copy and the attribute copy may also be marked in other manners, which is not limited by the present disclosure.

Operation S306: response information from a respective replica server is received after the data copy in the respective replica server completes update.

Similar to the method for updating the data copy, the attribute replica server, after receiving the attribute update request, reads the current version number in the attribute update request and compares whether the stored version number is less than the current version number. If the stored version number is smaller than the current version number, the stored version number is updated to the current version number and the response information is sent to the client terminal.

Operation S308: When the number of the response information received within the preset update time is less than the total number of the replica servers, the status of the copy information corresponding to the replica server that has not sent the response information is modified to the status of continuing to update.

As shown from the above description, when the number of response information received by the client terminal reaches a preset threshold, the data update is deemed to he successful. In this example embodiment, the response information includes the response information of the data replica server and the response information of the attribute replica server.

Operation S310: When the response information sent by the replica server that continues to update is not received within a preset continuous update time, the copy information corresponding to such replica server is deleted from the copy list.

Operation S312: The list attribute value of the copy list is updated, and the updated list attribute value is sent and stored in the central server.

After the client terminal updates the list attribute value, the updated list attribute value is also sent and stored in the corresponding attribute replica server in the copy list, which is not described in detail in the present disclosure.

It should be noted that in the above description the data copy update and the attribute copy update are performed in one thread. However, the technical solutions in the example embodiments of the present disclosure are not limited thereto. The attribute update request is generated in operation S302, and the attribute update request is sent to the attribute replica server in operation S304. These two operations may be performed after S308. The data copy update and such operations may be performed in two threads. For example, a data update request is sent to the data replica server, and response information sent by the data replica server is received. When the number of response information received within the preset update time is less than the total number of data copies, an attribute update request is generated, and the attribute update request is sent to the attribute replica servers respectively.

Since an attribute copy is added in this example embodiment, and when the number of response information that the client terminal receives with respect to the data copy and the attribute copy is greater than or equal to the preset threshold, the data update is considered to be successful. The techniques of the present disclosure thus increase the tolerable I/O performance jitter and system usability.

In addition, in this example embodiment, the process of data recovery performed by the client terminal is similar to that of the foregoing example embodiment, and the process of information interaction in this example embodiment is also similar to the foregoing embodiment, and thus details are not described herein again in the present disclosure.

Since the attribute copy of the data is introduced in this example embodiment and the attribute copy only includes the valid version number of the data and the list attribute value, even if the data is updated several times continuously, the attribute copy is updated at a faster speed. Therefore, as long as there is one attribute copy in the attribute replica server that is successfully updated, the version number of the valid version is determined. When the client terminal performs data recovery, as long as the version number of one data copy is equal to the version number of the attribute copy in the copy list, such data copy is identified as a valid copy.

According to the above description, in the data updating method provided by the example embodiment of the present disclosure, after the client terminal respectively sends the update requests to the replica servers listed in the copy list, the client terminal receives the response information from each respective replica server after the data copy in the respective replica server is updated completely. When the number of response information received within the preset update time is less than the total number of replica servers, there exists one or more replica servers that have not been successfully updated. In this case, in the example embodiment of the present disclosure, such replica servers are not excluded. Instead, the status of copy information corresponding to the replica server that does not send the response information is modified to the status of continuing to update to keep the replica server continue to be updated. If the response information sent by the replica server that continues to be updated is still not received within the preset continuous update time, the copy information corresponding to the replica server is deleted from the copy list, and thus the data replica is excluded from the data copies that have been successfully updated. Since the deletion of the copy information changes the list attribute of the copy list, in the example embodiment of the present disclosure, the list attribute value of the copy list is updated, and the updated list attribute value is sent and stored in the central server. Compared with the conventional techniques, when there is a replica server that has not been successfully updated within the update time, the replica server does not need to be excluded. Therefore, the current version number does not need to be stored in the central server. When excluding the replica server, changes to the copy list are bound to occur. Therefore, in the example embodiment of the present disclosure, the list attribute value is stored in the central server only when the copy list changes, thereby reducing the frequency of writing data to the central server based on reducing the I/O performance jitter, and further reducing the pressure on the central server and improving the system usability.

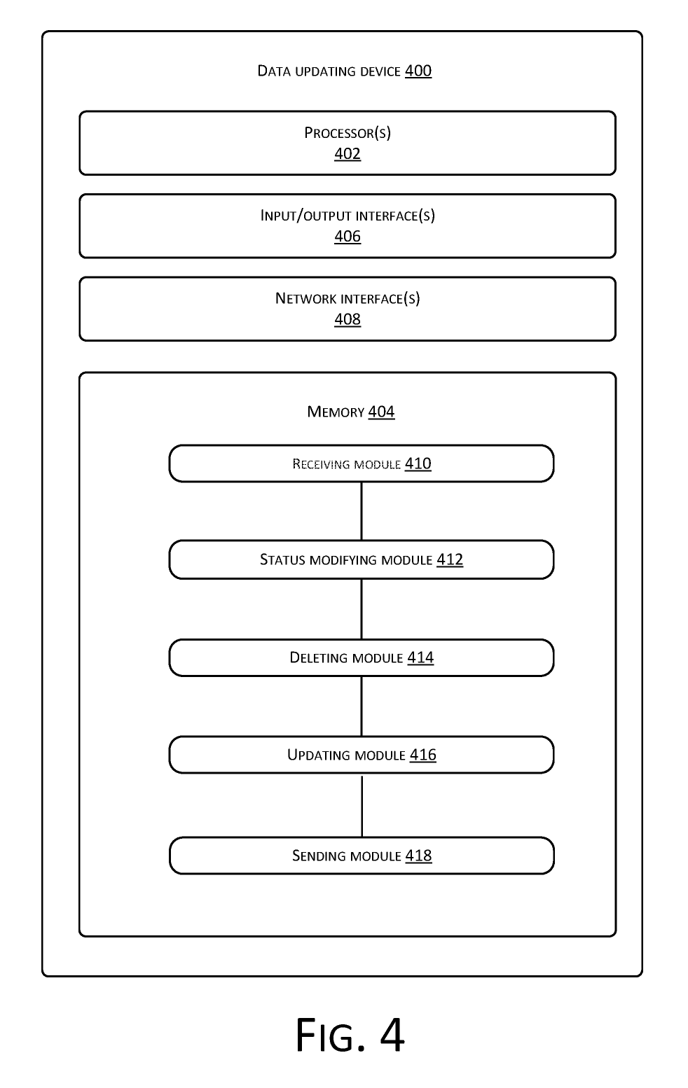

Corresponding to the above implementation method, the example embodiment of the present disclosure further provides a corresponding data updating device. Referring to FIG. 4, FIG. 4 is a schematic structural diagram of a data updating device 400 according to an example embodiment of the present disclosure. The data updating device 400 includes one or more processor(s) 402 or data processing unit(s) and memory 404. The data updating device 400 may further include one or more input/output interface(s) 406 and one or more network interface(s) 408. The memory 404 is an example of computer readable media.

Computer readable media, including both permanent and non-permanent, removable and non-removable media, may be stored by any method or technology for storage of information. The information can be computer readable instructions, data structures, modules of programs, or other data. Examples of computer storage media include, but are not limited to, phase change memory (PRAM), static random access memory (SRAM), dynamic random access memory (DRAM), other types of random access memory (RAM), read only memory Such as ROM, EEPROM, flash memory or other memory technology, CD-ROM, DVD, or other optical storage, Magnetic cassettes, magnetic tape magnetic tape storage or other magnetic storage devices, or any other non-transitory medium, may be used to store information that may be accessed by a computing device. As defined herein, computer-readable media do not include non-transitory transitory media such as modulated data signals and carriers.

The memory 404 may store therein a plurality of modules or units including a receiving module 410, a status modifying module 412, a deleting module 414, an updating module 416, and a sending module 418.

The receiving module 410, after sending update requests to replica servers listed in a copy list, receives response information from a respective replica server after a respective data copy in the respective replica server completes an update.

The status modifying module 412, when the number of the response information received in a preset update time is less than the total number of the replica servers, modifies the copy information corresponding to replica servers that have not sent the response information to status of continuing to update;

The deleting module 414, when response information from the replica servers with the status of continuing to update have not been received within a preset continuous update time, deletes copy information corresponding to the replica servers with the status of continuing to update from the copy list.

The updating module 416 updates list attribute values of the copy list after the deleting module 414 deletes such copy information from the copy list.

The sending module 418 sends and stores the updated list attribute values updated by the updating module 416 to the central server.

For the implementation process of the functions and functions of each module in the device, reference may be made to the corresponding implementation process in the foregoing method, and details are not described herein again.

As shown from this example embodiment, the data updating device in this example embodiment of the present disclosure does not need to exclude a replica server when there is the replica server that has not been successfully updated within the update time and therefore does not need to store the current version number in the central server. When excluding the replica server, changes to the copy list are bound to occur. Therefore, in the example embodiment of the present disclosure, the list attribute value is stored in the central server only when the copy list changes, thereby reducing the frequency of writing data to the central server based on reducing I/O performance jitter, and further reducing the pressure on the central server and improving the system usability.

Based on the foregoing example embodiment, the data updating device 400 may further includes a generating module (not shown in the FIGs) stored in memory 404. The generating module generates a data update request and an attribute update request. The attribute update request is a request for updating a version number. in the example embodiment of the present disclosure, the generating module 15 sends the data update request respectively to the data replica servers storing the data copies in the copy list, and sends the attribute update request to the attribute replica servers storing the attribute information in the copy list.

Based on the foregoing example embodiment, the generating module may specifically generate the attribute update request according to the version number of the copy corresponding to the response information. The sending module 418 sends the updated list attribute value and stores the updated list attribute value to the replica server listed in the copy list respectively.

Based on the foregoing example embodiment, the data updating device 400 may further includes an acquiring module and a storing module (not shown in the FIGs) stored in memory 404. The acquiring module acquires the historical list attribute value and the historical replica server address from the central server. The historical replica server address is a replica server address stored in a copy list sent according to a preset period. The storing module, when the prestored list attribute value is greater than or equal to the historical list attribute value, stores the address corresponding to the replica server in the copy list. In this example embodiment, the sending module 418 further sends query information to the replica servers corresponding to the historical replica server addresses respectively. The receiving module 410 receives the prestored list attribute value sent by the replica server in response to the query information.

In another example embodiment, the data updating device 400 may further includes a determining module (not shown in the FIGs) stored in memory 404. The determining module determines the data copy corresponding to the copy information with the highest or latest version number as a valid copy. In this example embodiment, the acquiring module acquires a version number in each piece of the copy information; and the deleting module 414 deletes copy information whose version numbers are smaller than the highest or latest version number from the copy list. The updating module 416 updates the list attribute value of the copy list to obtain a new list attribute value and the sending module 418 sends and stores the new list attribute value of the central server.

For the implementation process of the functions and functions of each module in the apparatus, reference may be made to the corresponding implementation process in the foregoing method, and details are not described herein again.

As shown from the above description, compared with the conventional techniques, the data updating device provided in this example embodiment of the present disclosure does not need to exclude a replica server when the replica server has not been successfully updated within the update time. Thus, there is no need to store the current version number in the central server. When excluding the replica server, changes to the copy list are bound to occur. Therefore, in the example embodiment of the present disclosure, the list attribute value is stored in the central server only when the copy list changes, thereby reducing the frequency of writing data to the central server based on reducing I/O performance jitter, and further reducing the pressure on the central server and improving the system usability.

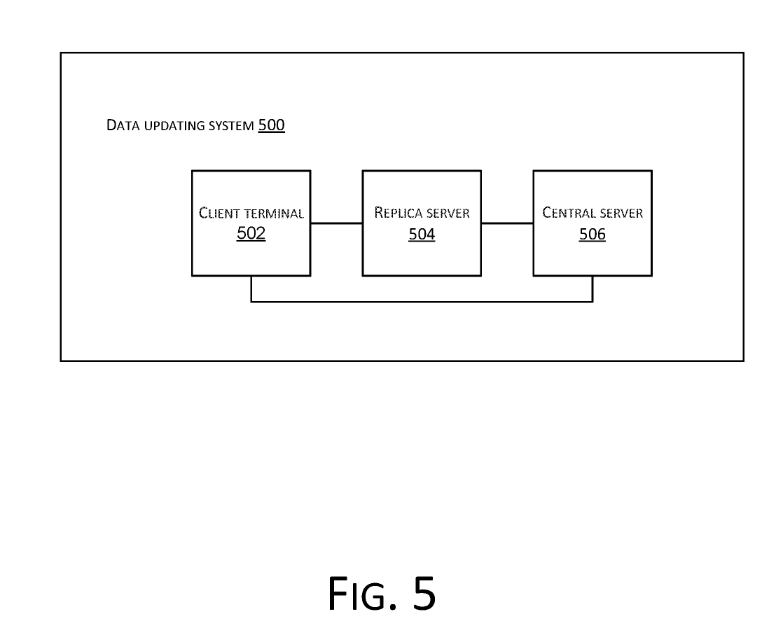

Corresponding to the foregoing method and device, an example embodiment of the present disclosure further provides a data updating system. As shown in FIG. 5, FIG. 5 is a schematic structural diagram of a data updating system 500 according to the example embodiment of the present disclosure. The system includes a client terminal 502, a replica server 504, and a central server 506. The client terminal 502 includes the foregoing data updating device whose functions and actions are not described again in this example embodiment of the present disclosure.

As shown from the above description, the central server 506 further sends a request for acquiring copy information to the replica server 504, receives the copy information sent by the replica server 504, determines an address list according to the copy information, and sends the stored list attribute value and the address list to the client terminal 502. The replica server 504 receives the request for acquiring the copy information sent by the central server 506, and sends the copy information to the central server 506. The specific implementation method may refer to the foregoing description, which is not described herein again in the example embodiment of the present disclosure.

The present disclosure is applicable to many general purpose or special purpose mobile terminals, such as mobile phones, tablet, and the like.

Overall, in order to solve the problem of low system usability, the data updating method and apparatus and the related system provided by the example embodiments of the present disclosure receive the update request from each replica server stored in the copy list respectively after the client terminal sends the update request the replica servers listed in the copy list. When the number of response information received within the preset update time is less than the total number of replica servers, there is a replica server that has not been successfully updated. In this case, in this embodiment of the present disclosure, such replica server is not excluded. Instead, the status of such replica server that has not sent the response information is modified to the status of continuing to update to keep the replica server to continue updating. If the response information sent by the replica server that continues to be updated is still not received within the preset continuous update time, the copy information corresponding to such replica server is deleted from the copy list, and thus the data copy corresponding to the copy information is deleted from the data copies that have been successfully updated. As the deletion of the copy information changes the list attribute of the copy list, in the example embodiment of the present disclosure, the list attribute value of the copy list is updated, and the updated list attribute value is sent and stored to the central server. Compared with the conventional techniques, when there is a replica server that has not been successfully updated within the update time, the replica server does not need to be excluded. Therefore, the current version number does not need to be stored in the central server. When excluding the replica server, changes to the copy list are bound to occur. Therefore, in the example embodiment of the present disclosure, the list attribute value is stored in the central server only when the copy list changes, thereby reducing the frequency to write data into the central server based on reducing the I/O performance jitter, and further reducing the pressure on the central server and improving the system usability.

The above descriptions are only example embodiments of the present disclosure. One of ordinary skill in the art may make changes and modifications without departing from the principles of the present disclosure. Such changes and modifications also fall under the protection of the present disclosure.

The present disclosure may further be understood with clauses as follows.

Clause 1. A data updating method comprising:

after sending update requests to replica servers listed in a copy list, receiving response information from a respective replica server after a respective data copy in the respective replica server completes an update;

when a number of response information received in a preset update time is less than a total number of the replica servers, modifying copy information corresponding to a replica server that has not sent a response information to status of continuing to update;

when response information from the replica servers with the status of continuing to update have not been received within a preset continuous update time, deleting the copy information from the copy list;

updating a list attribute value of the copy list; and

sending and storing the updated list attribute value to the central server.

Clause 2. The method of clause 1, wherein, prior to the receiving response information from a respective replica server after a respective data copy in the respective replica server completes an update, the method further comprises:

generating a data update request and an attribute update request, the attribute update request requesting to update version number;

sending the data update request to data replica servers storing data copies in the copy list respectively; and

sending the attribute update request to attribute replica servers storing attribute information in the copy list respectively.

Clause 3. The method of clause 1, further comprising:

when the number of response information received in the preset update time is less than the total number of the replica servers,

generating an attribute update request according to a version number of a copy corresponding to the response information; and

sending the attribute update request to the attribute replica server.

Clause 4. The method of clause 1, further comprising:

after updating the list attribute value of the copy list and prior to sending and storing the updated list attribute value to the central server,

sending and storing the update list attribute value to the replica servers listed in the copy list respectively.

Clause 5. The method of any of clauses 1 to 4, further comprising:

acquiring a historical list attribute value and a historical replica server address from a central server, the historical replica server address being a replica server address listed in the copy list that is sent according to a preset period;

sending inquiry information to a replica server corresponding to the historical replica server address;

receiving a prestored list attribute value that is sent by a replica server in response to the inquiry information;

when the prestored list attribute value is larger than or equal to the historical list attribute value, storing an address corresponding to the replica server in the copy list.

Clause 6. The method of clause 5, further comprising:

after storing the address corresponding to the replica server in the copy list,

acquiring version number of each copy information;

determining a data copy corresponding to copy information with a highest version number as a valid copy;

deleting one or more copy information whose version numbers less than the highest version number from the copy list;

updating a list attribute value of the copy list to obtain a new list attribute value; and

sending and storing the new list attribute value to the central server.

Clause 7 A data updating device comprising:

a receiving module that, after sending update requests to replica servers listed in a copy list, receives response information from a respective replica server after a respective data copy in the respective replica server completes an update;

a status modifying module that, when a number of response information received in a preset update time is less than a total number of the replica servers, modifies copy information corresponding to a replica server that has not sent a response information to status of continuing to update;

a deleting module that, when response information from the replica servers with the status of continuing to update have not been received within a preset continuous update time, deletes the copy information from the copy list;

an updating module that updates a list attribute value of the copy list after the deleting module deletes the copy information from the copy list; and

a sending module that sends and stores the updated list attribute value that is updated by the updating module to the central server.

Clause 8. The device of clause 7, further comprising:

a generating module that generates a data update request and an attribute update request, the attribute update request requesting to update version number; and

a sending module that sends the data update request to data replica servers storing data copies in the copy list respectively and sends the attribute update request to attribute replica servers storing attribute information in the copy list respectively.

Clause 9. The device of clause 7, wherein:

the generating module generates generating an attribute update request according to a version number of a copy corresponding to the response information.

Clause 10. The device of clause 7, wherein:

the sending module sends and stores the update list attribute value to the replica servers listed in the copy list respectively.

Clause 11. The device of any of clauses 7 to 10, further comprising:

an acquiring module and a storing module,

wherein:

the acquiring module obtains a historical list attribute value and a historical replica server address from a central server, the historical replica server address being a replica server address listed in the copy list that is sent according to a preset period;

the sending module sends inquiry information to a replica server corresponding to the historical replica server address;

the receiving module receives a prestored list attribute value that is sent by a replica server in response to the inquiry information; and

the storing module, when the prestored list attribute value is larger than or equal to the historical list attribute value, stores an address corresponding to the replica server in the copy list.

Clause 12. The device of clause 11, further comprising:

a determining module,

wherein:

the acquiring module acquires version number of each copy information;

the determining module determines a data copy corresponding to copy information with a highest version number as a valid copy;

the deleting module deletes one or more copy information whose version numbers less than the highest version number from the copy list;

the updating module updates a list attribute value of the copy list to obtain a new list attribute value; and

sending and storing the new list attribute value to a central server.

Clause 13. A data updating system comprising:

a central server that sends a request to acquire copy information to a replica server, receives copy information sent by the replica server, determining an address list according to the copy information, and sends the stored list attribute value and the address list to a client terminal; and

the replica server that receives request to acquire copy information sent by the central server, and sends the copy information to the central server.

What is claimed is:

1. A method comprising:
sending an update request to replica servers listed in a copy list respectively;
receiving respective response information from a respective replica server of the replica servers after an update of a respective data copy in the respective replica server is completed;
in response to determining that a number of response information received in a preset update time is less than a total number of the replica servers, modifying a status of copy information corresponding to a replica server that has not sent a response information to a status of continuing to update; and
in response to determining that response information from the replica servers with the status of continuing to update has not been received within a preset continuous update time, deleting copy information corresponding to the replica server from the copy list.

2. The method of claim 1, wherein the copy list includes:
an address of the respective replica server;
a version number of a respective data copy stored at the respective replica server; and
a status of respective copy information corresponding to the respective data copy.

3. The method of claim 1, further comprising:
prior to the receiving the response information from the respective replica server of the replica servers after the update of the respective data copy in the respective replica server is completed:
generating a data update request and an attribute update request, the attribute update request requesting to update a version number;
sending the data update request to data replica servers, storing data copies, in the copy list respectively; and
sending the attribute update request to attribute replica servers, storing attribute information, in the copy list respectively.

4. The method of claim 1, further comprising:
in response to determining that the number of response information received in the preset update time is less than the total number of the replica servers,
generating an attribute update request according to a version number of a respective data copy corresponding to the respective response information; and
sending the attribute update request to an attribute replica server.

5. The method of claim 1, further comprising updating a list attribute value of the copy list.

6. The method of claim 5, further comprising sending the updated list attribute value to a central server.

7. The method of claim 1, further comprising:
after the updating the list attribute value of the copy list and prior to sending the updated list attribute value to the central server for storage,
sending the updated list attribute value to the replica servers listed in the copy list respectively.

8. The method of claim 1, further comprising:
acquiring historical list attribute values and historical replica server addresses from a central server, the historical replica server addresses being replica server addresses listed in the copy list that is stored according to a preset period;
sending inquiry information to replica servers corresponding to the historical replica server addresses respectively;
receiving a respective prestored list attribute value that is sent by the respective replica server in response to the inquiry information; and
in response to determining that the prestored list attribute value is larger than or equal to the historical list attribute value, storing an address corresponding to the respective replica server in the copy list.

9. The method of claim 7, further comprising:
after storing the address corresponding to the respective replica server in the copy list,
acquiring a version number of respective copy information;
determining a data copy corresponding to copy information with a highest or latest version number as a valid copy; and
deleting one or more copy information whose version numbers are less than the highest or latest version number from the copy list.

10. The method of claim 8, further comprising:
updating a list attribute value of the copy list to obtain a new list attribute value; and
sending the new list attribute value to the central server for storage.

11. A device comprising:
one or more processors; and
one or more memories storing thereon computer-readable instructions that, when executed by the one or more processors, cause the one or more processors to perform acts comprising:
sending an update request to replica servers listed in a copy list respectively;
receiving respective response information from a respective replica server of the replica servers after an update of a respective data copy in the respective replica server is completed;
in response to determining that a number of response information received in a preset update time is less than a total number of the replica servers, modifying a status of copy information corresponding to a replica server that has not sent a response information to a status of continuing to update; and
in response to determining that response information from the replica servers with the status of continuing to update has not been received within a preset continuous update time, deleting copy information corresponding to the replica server from the copy list.

12. The device of claim 11, wherein the copy list includes:
an address of the respective replica server;
a version number of a respective data copy stored at the respective replica server; and
a status of respective copy information corresponding to the respective data copy.

13. The device of claim 12, wherein the acts further comprise:
prior to the receiving the response information from the respective replica server of the replica servers after the update of the respective data copy in the respective replica server is completed:
generating a data update request and an attribute update request, the attribute update request requesting to update a version number;
sending the data update request to data replica servers, storing data copies, in the copy list respectively; and
sending the attribute update request to attribute replica servers, storing attribute information, in the copy list respectively.

14. The device of claim 11, wherein the acts further comprise:
in response to determining that the number of response information received in the preset update time is less than the total number of the replica servers,
generating an attribute update request according to a version number of a respective data copy corresponding to the respective response information; and
sending the attribute update request to an attribute replica server.

15. The device of claim 11, wherein the acts further comprise updating a list attribute value of the copy list.

16. The device of claim 15, wherein the acts further comprise sending the updated list attribute value to a central server.

17. The device of claim 11, wherein the acts further comprise:
after the updating the list attribute value of the copy list and prior to sending the updated list attribute value to the central server for storage,
sending the updated list attribute value to the replica servers listed in the copy list respectively.

18. The device of claim 11, wherein the acts further comprise:
acquiring historical list attribute values and historical replica server addresses from a central server, the historical replica server addresses being replica server addresses listed in the copy list that is stored according to a preset period;
sending inquiry information to replica servers corresponding to the historical replica server addresses respectively;
receiving a respective prestored list attribute value that is sent by the respective replica server in response to the inquiry information; and
in response to determining that the prestored list attribute value is larger than or equal to the historical list attribute value, storing an address corresponding to the respective replica server in the copy list.

19. The device of claim 18, wherein the acts further comprise:
after storing the address corresponding to the respective replica server in the copy list,
acquiring a version number of respective copy information;
determining a data copy corresponding to copy information with a highest or latest version number as a valid copy;
deleting one or more copy information whose version numbers are less than the highest or latest version number from the copy list;
updating a list attribute value of the copy list to obtain a new list attribute value; and
sending the new list attribute value to the central server for storage.

20. One or more memories storing thereon computer-readable instructions that, when executed by the one or more processors, cause the one or more processors to perform acts comprising:
sending an update request to replica servers listed in a copy list respectively;
receiving respective response information from a respective replica server of the replica servers after an update of a respective data copy in the respective replica server is completed;
in response to determining that a number of response information received in a preset update time is less than a total number of the replica servers, modifying a status of copy information corresponding to a replica server that has not sent a response information to a status of continuing to update;
in response to determining that response information from the replica servers with the status of continuing to update has not been received within a preset continuous update time, deleting copy information corresponding to the replica server from the copy list;
updating a list attribute value of the copy list; and
sending the updated list attribute value to a central server.
